(19) United States
(12) Patent Application Publication
(10) Pub. No.: US 2025/0264323 A1
(43) Pub. Date: Aug. 21, 2025

(54) METHOD FOR COMPENSATING THE ARTIFACTS GENERATED BY MOVING MEASUREMENT OBJECTS IN MEASUREMENT SIGNALS OF SWEPT-SOURCE OCT SYSTEMS

(71) Applicant: Carl Zeiss Meditec AG, Jena (DE)

(72) Inventors: Rainer Leitgeb, Wien (AT); Michael Niederleithner, Wien (AT)

(21) Appl. No.: 19/197,529

(22) Filed: May 2, 2025

Related U.S. Application Data
(63) Continuation of application No. 17/282,641, filed on Sep. 8, 2021, now Pat. No. 12,313,402.

(30) Foreign Application Priority Data
Oct. 2, 2018 (DE) 10 2008 007 757.9

(51) Int. Cl. G01B 9/02055; G01B 9/02004; G01B 9/02091; G06T 11/00

(52) U.S. Cl. CPC G01B 9/02077; G01B 9/02004; G01B 9/02091; G06T 11/005

(57) ABSTRACT

A method for compensating the artifacts generated by moving measurement objects in measurement signals of swept-source OCT systems by moving measurement objects. Signal reconstruction is implemented without the aid of additional reference signals in respect of the movement of the measurement object and only by way of especially adapted algorithms. Example methods relate firstly to the especially adapted, Fourier transform-based algorithms for processing the captured measurement signals and secondly to the measurement signals to be captured, in particular to the optical coherence interferometry-based measurement systems used for the production thereof. Although the proposed method is provided for applications in ophthalmology in particular, it can be used, in principle, wherever signals reflected by curved surfaces or backscattered from structures are analyzed.

### RELATED APPLICATIONS

This application is a continuation of U.S. patent application Ser. No. 17/282,641, filed Sep. 8, 2021, entitled “Method for Compensating the Artifacts Generated by Moving Measurement Objects in Measurement Signals of Swept-Source OCT Systems,” which is a National Phase entry of PCT Application No. PCT/EP2019/076592 filed Oct. 1, 2019, which application claims the benefit of priority to DE Application No. 10 2018 007 757.9 filed, Oct. 2, 2018, the entire disclosures of which are incorporated herein by reference.

### TECHNICAL FIELD

The present invention relates to a method that can be used to numerically compensate artifacts generated in measurement signals from OCT systems by moving measurement objects and to produce measurement signals without artifacts.

### BACKGROUND

In the last two decades, optical biometry has become established worldwide and is the preferred measurement process in industrial countries for determining the biometric data before cataract operations, in particular. The measuring technique utilized to this end requires a high sensitivity.

According to the known prior art, lasers with a changeable or tunable wavelength lend themselves as a light source to this measuring technique since they can achieve the required high sensitivities. However, currently commercially available lasers with a changeable wavelength are very expensive, making the measuring technique extremely costly and preventing a wide application.

To facilitate the use even in newly industrialized countries, where many patients have very pronounced cataracts, it is necessary for the costs of this measuring technique to be reduced substantially, albeit without changing the sensitivity.

By way of example, simple VCSEL lasers or DFB lasers lend themselves as an alternative light source, as these are substantially more cost-effective and are able to be tuned thermally and/or electrically over a wavelength range of several nanometers.

However, a disadvantage of such lasers is that they can only realize a sweep duration in a region greater than 1 ms, but this is too slow for measurements in the living eye. This results in movement artifacts, which have to be compensated in order to ensure a high sensitivity and sufficient reproducibility, in the case of measurements on the living eye.

US 2017/105618 A describes an improved imaging system based on an interferometric frequency, domain or Fourier domain OCT (FD-OCT). There are two usual approaches for FD-OCT. One is the spectral domain OCT (SD-OCT), in which the interfering light is spectrally decomposed prior to detection and the complete depth information can be obtained from a single exposure. The second is swept source OCT (SS-OCT), in which the source is tuned over a range of optical frequencies and detected in time, as a result of which the spectral information is encoded in time. Although both techniques have already found use in ophthalmology, they also have a number of weaknesses. A number of systems that represent improvements for interferometric imaging techniques are described below. In addition to improvements within the scope of scanning, the reconstruction and representation of the signals, the illumination, or the optimization of reference signals, movement correction is also considered. If movement artifacts cannot be avoided, they can be corrected computationally. Thus, local movements corrections can be applied either in the spatial domain or in the frequency domain. In the frequency domain, they can be applied in the form of frequency-dependent movement corrections.

### LITERATURE

[1] Niederleithner, M.; “Feasibility of a thermally tuned laser diode as a light source for eye biometry”; Master's thesis, TU Vienna, July 2018

### SUMMARY OF THE INVENTION

Embodiments of the present invention address the problem of developing a solution that allows compensation of the artifacts generated in measurement signals of OCT systems by moving measurement objects, wherein additional technical means should be dispensed with to the greatest possible extent. In particular, the solution should allow the production of cost-effective biometric measurement systems, which ensure a high sensitivity and a sufficient reproducibility.

An example method for compensating the artifacts generated in measurement signals of swept source OCT systems by moving measurement objects achieves this object by virtue of the signal reconstruction being implemented without the aid of additional reference signals in respect of the movement of the measurement object and only by way of especially adapted algorithms.

Example developments and configurations, relate firstly to the especially adapted, Fourier transform-based algorithms for processing the captured measurement signals.

Secondly, the example developments and configurations relate to the measurement signals to be captured, in particular to the optical coherence interferometry-based measurement systems used for the production thereof.

Although the example method is provided for applications in ophthalmology in particular, particularly for capturing the biometric data of an eye, it can be used, in principle, wherever signals reflected by curved surfaces or backscattered from structures are analyzed.

### BRIEF DESCRIPTION OF THE DRAWINGS

The invention is described in more detail below on the basis of exemplary embodiments.

In this respect:

FIG. 1A: depicts the curves of the amplitude of two-phase-shifted signals over time,

FIG. 1B: depicts the absolute value of the Fourier transform of the two phase shifted signals,

FIG. 2A: depicts the signal curve and the phase for the function y=cos (t2+t),

FIG. 2B: depicts the Fourier transform of y as a so-called linear chirp,

FIG. 3: depicts the algorithm for relinearizing a signal for only one reflection,

FIG. 4: depicts the algorithm for relinearizing a signal with multiple reflections,

FIG. 5: depicts the algorithm for adding a quadratic part to the transformation in order to generate a linear chirp,

FIG. 6: depicts the algorithm for relinearizing a signal with only a single reflection, and

FIGS. 7-9: depicts Fourier transformed spectra before and after the reconstruction with FRFT for measurement objects moving at different speeds.

### DETAILED DESCRIPTION

### Definitions

Sweep: Tuning a wavelength over a wavelength range
Sweep range: Wavelength range over which a wavelength is tuned
Chirped signal: Signal with a frequency spectrum
Linear chirp: Signal with a linear frequency spectrum
Relinearization: Interferometric signal with non-constant distances between the maxima (nonlinear phase response) is brought to a linear phase response with the aid of the remapping.
Remapping: In theory, the spectral interference signal in Fourier domain OCT is a linear function of the wave number. However, in practice it deviates from linearity and this is corrected by the remapping. (=Relinearization). In very general terms, it is a method for mapping the components of a signal to a new one by way of a defined function.

In an example method for compensating the artifacts generated in measurement signals of swept source OCT systems by moving measurement objects, the signal reconstruction is implemented without the aid of additional reference signals in respect of the movement of the measurement object and only by way of especially adapted algorithms. Axial, lateral, and further movement artifacts are compensated.

The cross-correlation term in low coherence interferometry (LCI) is as follows:

$${l}_{D} ( k ) = \frac{ρ}{2} S ( k ) {\sum }_{n = 1}^{N} \sqrt{{r}_{r} {r}_{{s}_{n}}} cos ( 2 k ( {z}_{r} - {z}_{{s}_{n}} ) ) \qquad ( 1 )$$

For a single reflecting surface, the equation reduces to:

$${l}_{D} ( k ) ∝ cos ( 2 k ( {z}_{r} - {z}_{s} ) ) = cos ( 2 k Δ z ) \qquad ( 2 )$$

where the Fourier pair are k and z in this case.

In swept source LCI, a sweep is carried out over the time t. The position of the measurement object can change during this time. To describe this behavior, the process must be described over time (t). This means that the wavenumber k(t) and the distance Δz(t) become functions of t:

$${l}_{D} ( k ) ∝ cos ( 2 k ( t ) Δ z ( t ) ) \qquad ( 3 )$$

On account of the change in the parameter of the function, the Fourier pair must also be changed from z and k to ω and t. If this is a linearly tuning source, k(t) is a linear function:

$$k ( t ) = {k}_{1} t + {k}_{0} \qquad ( 4 )$$

$$k = \frac{{k}_{e} - {k}_{0}}{T} \qquad ( 5 )$$

where k₁ is the slope of a sweep, kₑ is the mean wavenumber and T is the sweep time.

For a stationary measurement object, Δz(t)=z is a constant function and, by inserting the equation (5) into equation (3), leads to:

$${I}_{D} ( k ) ∝ cos ( 2 ( {k}_{1} t + {k}_{0} ) z ) = cos ( 2 {k}_{1} zt + 2 {k}_{0} z ) {︸}_{ω} {︸}_{Φ} \qquad ( 6 )$$

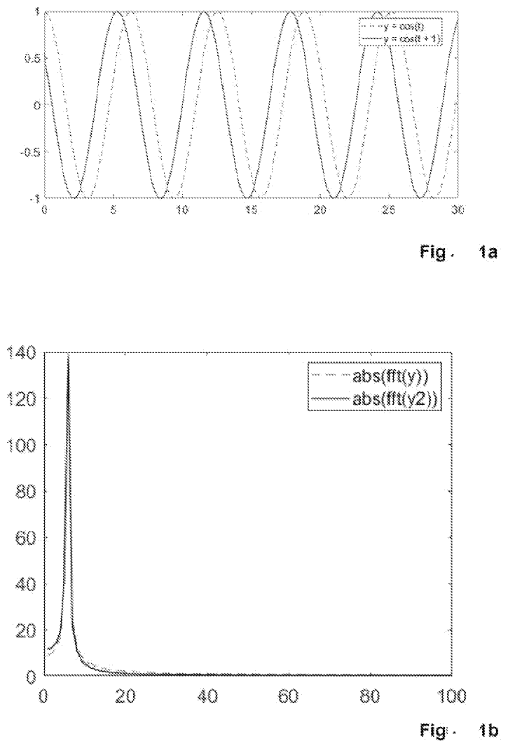

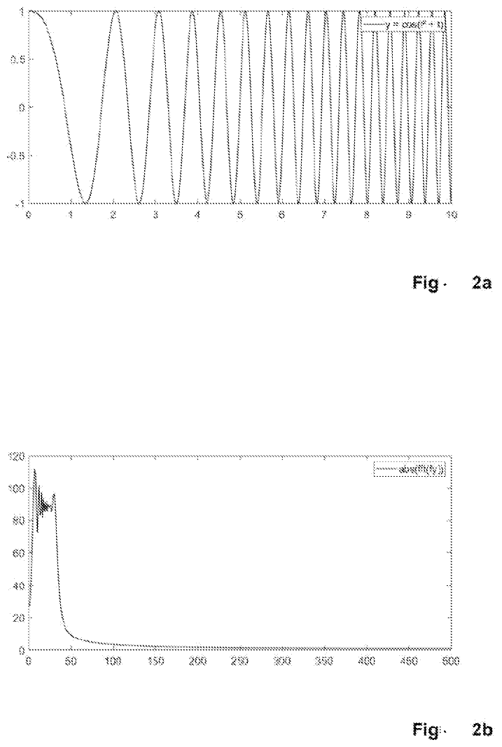

The phase shift ϕ does not change the frequency ω of the signal. The Fourier transform t z leads t [symbol] ingle frequency, which is illustrated in FIG. 1. This is the expected behavior for a reflecting, stationary measurement object.

FIG. 1 shows in graph a) the curves of the amplitudes of the phase-shifted signals y=cos (t) (blue) and y=cos (t+1) (red) over time. Graph b) shows the absolute value of the Fourier transform of the two signals. It is evident that both signals lead to the same Fourier transform.

Now, if the measurement object moves during a sweep, the position thereof is no longer constant but also changes as a function of time t.

The simplest case is a linear movement in the axial direction, where z(t) becomes:

$$Δ z ( t ) = vt + {z}_{0} \qquad ( 7 )$$

where v is the speed and z₀ is the initial position. Inserting (7) and (4) into (3) again leads to:

$${I}_{D} ( k ) ∝ cos {( 2 [ {k}_{1} {vt}^{2} + \underbrace{( {k}_{1} {z}_{0} + {k}_{0} v ) t} + {k}_{0} {z}_{0} ] )}_{ω ( t ) Φ} == cos ( 2 [ ( {k}_{1} vt + {k}_{1} {z}_{0} + {k}_{0} v ) t + {k}_{0} {z}_{0} ) \qquad ( 8 )$$

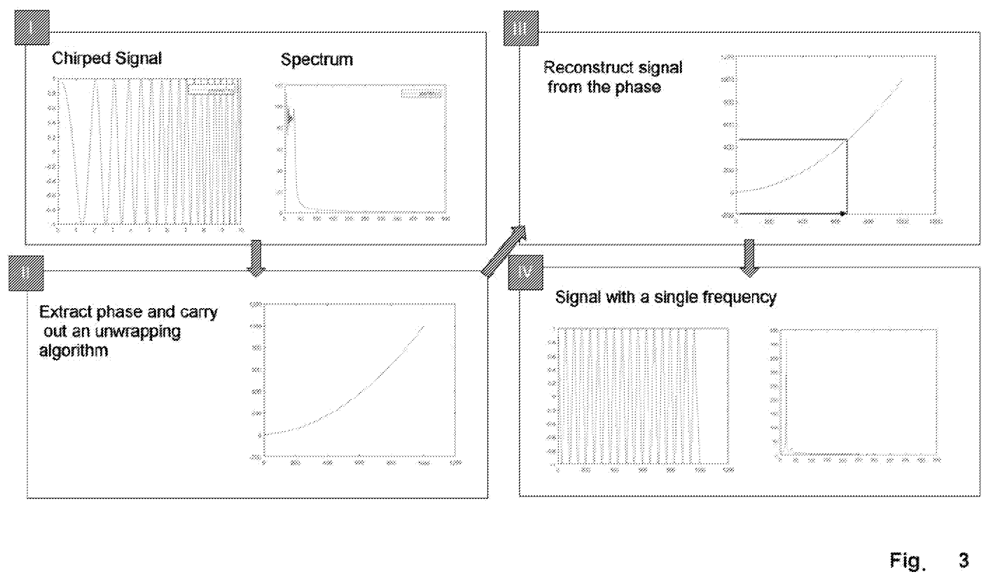

The parameter of the cosine term now consists of a quadratic part (left) and ω can be written as a linear function ω(t) (right). The phase is subject to (linear) acceleration and the Fourier transform no longer leads to a single frequency but to a spectrum of frequencies. Since ω(t) is a linear function, this is referred to as a linear chirp, which is illustrated in FIG. 2.

FIG. 2A shows the signal curve and the phase for the function y=cos (t²+t). FIG. 2b depicts the Fourier transform of y, as a so-called linear chirp.

The start frequency is given by ω (0)=k_{1z0}+k₀ᵥ. The end frequency depends on the sweep time T and is given by: ω(T)=k₁ᵥT+k_{1z0}+k₀ᵥ.

One process for reconstructing a chirped signal is the renewed linearization with remapping.

A real signal can be transformed into its analytic form by way of a Hilbert transform. This is a complex signal, the absolute value of which represents the same signal as the original real signal. The advantage of the complex form is that the phase can be derived easily, by way of:

$$Φ = a tan ( \frac{Im}{Re} ) .$$

The extracted phase can be used as remapping function which, when applied to a signal nonlinear in k, relinearizes the latter. This algorithm can be used if the measured sample consists of a single reflecting surface. A “phase unwrapping” can be applied on account of the periodicity.

In accordance with a first example configuration, the method according to the invention for a single reflection is characterized in that:
a) a chirped signal with an accelerating phase is captured,
b) the phase of this signal is extracted by carrying out the Hilbert transform,
c) the extracted phase is used to relinearize the signal, and
d) a reconstructed, non-chirped signal arises by application of the relinearization by remapping.

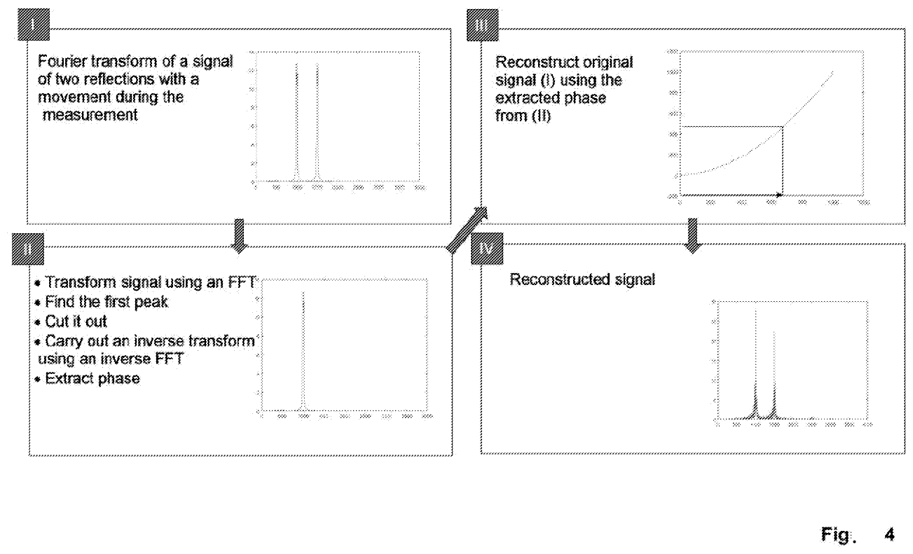

To this end, FIG. 3 shows the algorithm for relinearizing a signal for only one reflecting surface.
I: A chirped signal with an accelerated phase is captured.
II: The phase of this signal can be extracted by carrying out the Hilbert transform. It transforms the real signal into its analytic form. This is a complex signal, the absolute value of which corresponds to the real value. Then, the phase can be extracted from the angle between the imaginary and complex part. A “phase unwrapping” can also be applied on account of the periodicity.
III: The phase can be used as remapping function for the signal. The value of the phase can be used as an index.
IV: A non-chirped signal is obtained with the relinearization.

If the captured signal does not consist of only a single frequency on account of a plurality of reflecting surfaces, this algorithm cannot be applied without additional steps.

Knowledge of at least one discrete peak is required to be able to continue to apply this process. Then, the region which the chirp contains for this peak can be cut out and the phase can be extracted. The relinearization of this peak can also be applied to the entire signal, under the assumption that the entire sample has moved at the same speed.

To use this algorithm, the measured sample must consist of at least one discrete reflection, the chirp of which can be distinguished from another reflection.

If this chirp has already been superposed by other structures, it cannot be extracted.

In accordance with a second example configuration, the method according to the invention for a plurality of reflections is characterized in that:
a) a signal consisting of two or more reflections with the same speed is captured,
b) if the first reflection arises from a single surface, it is cut from the remainder of the signal for this signal, subject to Fourier transform, the signal being inverse transformed again and its phase being extracted,
c) the extracted phase is used to relinearize the entire original signal, and
d) a reconstructed, non-chirped signal arises by application of the relinearization by remapping.

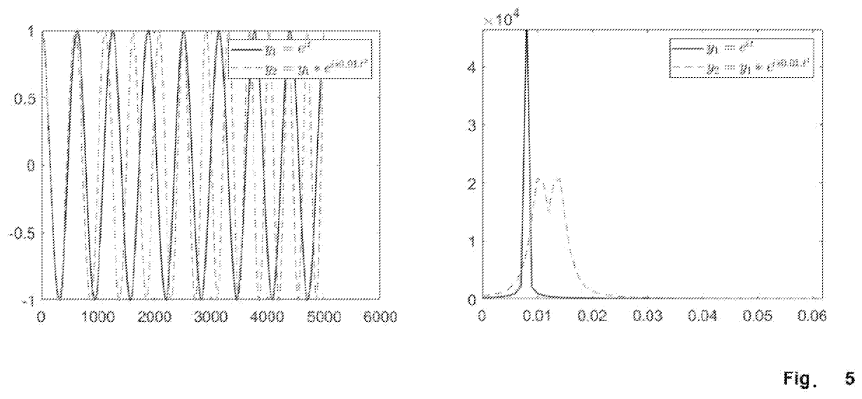

To this end, FIG. 4 depicts the algorithm for relinearizing a signal with multiple reflections.
I: The signal consists of two (usually several) reflections, all of which are at the same speed.
II: Knowledge about the structure is required for a further reconstruction. By way of example, if the first reflection is a single surface, it can be used for the relinearization. To this end, the signal can be Fourier transformed and the first chirp can be cut out of the remainder of the signal. Then, the signal must be inverse transformed again. This signal will be complex, and so the phase can be extracted directly.
III: Using this phase, it is possible to linearize the entire original signal.
IV: A reconstructed structure is obtained.

In accordance with a third configuration, the compensation is implemented, according to the invention, by application of a “fractional Fourier transform” (FRFT).

The use of a “fractional Fourier transform” (FRFT) represents a further process for reconstructing a chirped signal.

The “fractional Fourier transform” (FRFT), as a generalization of the conventional Fourier transform, is the convolution of a standard Fourier transform and a rotation in the frequency/time domain through the angle α:

$${X}_{α} ( u ) = {\int }_{- ∞}^{∞} x ( t ) {K}_{α} ( t , u ) dt \qquad ( 9 )$$

where x(t) is the original function and K_{α}(t; u) represents the rotation. The transformation is implemented as t u. The rotation can [symbol] e written as:

$${K}_{α} ( t , u ) = \{ \begin{matrix}δ ( t - u ) & α is a multiple of 2 π \\ δ ( t + u ) & α + π is a multiple of 2 π \\ \sqrt{\frac{1 - j cot ( α )}{2 π} {e}^{i \frac{{u}^{2} + {t}^{2}}{2}} cot ( α ) - i ut cosec ( α )} & otherwise\end{matrix} \qquad ( 10 )$$

Consequently, the FRFT becomes the unit operator for α as a multiple of 2π and the function is mirrored for α□+π as a multiple of 2π.

$$For α = \frac{π}{2} : cot ( \frac{π}{2} ) = 0 and cosec ( \frac{π}{2} ) = 1$$

the exponential function in (10) is reduced to e^{jut}, and inserted into (9) for the definition of the Fourier transform:

$${X}_{\frac{π}{2}} ( u ) = {\int }_{- ∞}^{∞} x ( t ) {e}^{j ut} dt \qquad ( 11 )$$

For arbitrary angles, equation (10) adds a quadratic component to the transform. As described above in equation (8), a quadratic component leads to a linear chirp.

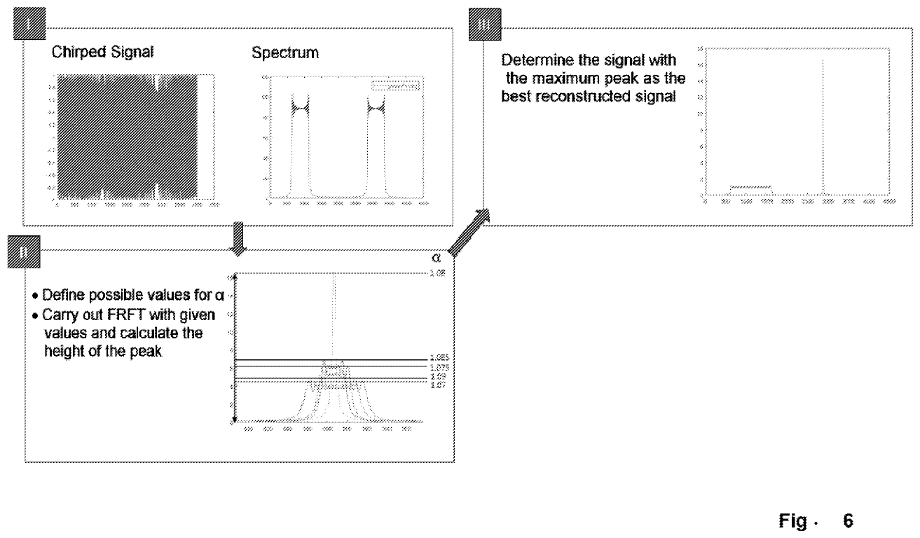

This algorithm for converting the transform into a linear chirp is illustrated in FIG. 5. A quadratic part is added to a signal with a single frequency (left graph). The right graph shows the spectra of the two functions resulting therefrom.

Therefore, the FRFT of a signal with a single frequency leads to a chirp in the frequency domain. On the other hand, a chirped signal can be transformed back to a single peak.

Some basic properties of FRFT:
X₀=I, is the identity operator,
Xπ/2=F, is the usual Fourier transform,
Xπ=P, is the parity operator,
X_{3π/2}=FP=PF, is the mirrored Fourier transform,
X₂π=X₀=I,
X₂πn□+□α=X₂πn′□+□αI, for arbitrary integers n and n′, and
Xα [symbol] =+Xα [symbol] , =Xα [symbol] +α [symbol] , index additivity.

A further important property of FRFT is that it satisfies Parseval's theorem:

$${\int }_{- ∞}^{∞} f ( t ) {g}^{*} ( t ) dt = {\int }_{- ∞}^{∞} {F}_{α} ( u ) {G}_{α}^{*} ( u ) du \qquad ( 12 )$$

where F_{α}(u) and G_{α}*(u) are the fractional Fourier transforms of f(t) and g*(t), respectively. If f(t)=g(t), equation (12) becomes:

$${\int }_{- ∞}^{∞} {\vert f ( t ) \vert}^{2} dt = {\int }_{- ∞}^{∞} {\vert {F}_{α} ( u ) \vert}^{2} du . \qquad ( 13 )$$

It shows that the integral (the sum in the discrete case) of the square of a function equals the integral of the square of its transformation, even under different angles (a).

A linear movement can be described by a constant speed:

$$z ( t ) = vt + {z}_{0} .$$

As already described in equation (8), this leads to an intensity proportional to:

$$exp ( 2 [ {k}_{1} {vt}^{2} + ( {k}_{1} {z}_{0} + {k}_{0} v ) t + {k}_{0} {z}_{0} ] ) .$$

Together with the rotation of the FRFT, the integrand becomes:

$$exp ( 2 i ( {k}_{1} {vt}^{2} + ( {k}_{1} {z}_{0} + {k}_{0} v ) t ) * exp ( - i \frac{{t}^{2}}{2} π cot ( α ) - i ut π cosec ( α ) ) == exp ( i [ 2 {k}_{1} v - \frac{1}{2} π cot ( α ) {t}^{2} + ( 2 {k}_{1} {z}_{0} + 2 {k}_{0} v - \frac{1}{2} π u cosec ( α ) ) t ) . \qquad ( 14 )$$

It is evident that for:

$$α = arccot ( \frac{2}{π} {k}_{1} v )$$

the quadratic part becomes zero and the signal can be described by a single frequency.

The fractional Fourier transform is able to dechirp a linear chirp at a certain angle. In the case of the eye length measurement, the speed which determines the extent of chirping is unknown. A minimization algorithm can be applied in order to obtain this information. Since there is a degree of freedom (a), it is necessary to determine a variable for the minimization.

Since the FRFT satisfies Parseval's theorem, one option consists in measuring the height of a peak (absolute value; intensity) in the frequency domain. As already shown in FIG. 5, chirping leads to a reduced maximum. Therefore, the signal with the highest maximum is the least chirped signal. The algorithm calculates the FRFT of the measured signal for a certain number of angles and checks the maximum of the signal. The signal with the highest maximum must be the least chirped signal.

The search interval of the maximum should be chosen carefully and set to locations at which the signals for the cornea and/or the retina are expected.

In detail, the compensation according to the invention for a single reflection by means of fractional Fourier transform (FRFT) is implemented by virtue of
a) the free parameter (angle) of the FRFT being altered iteratively, until a quality function reaches its maximum value,
b) the FRFT of the measured signal being calculated for a certain number of angles,
c) the parameter with the maximum signal value according to FRFT being determined,
d) said FRFT being used for the relinearization of the entire original signal, and
e) reconstructed, non-chirped signals arising by means of the relinearization by remapping.

In this case, it is advantageous for example if the quality function of the signal components summed over the measurement depth lies above a defined threshold.

It is furthermore advantageous for example to restrict the free parameter to expected axial speeds.

In particular nonlinear chirps can also be corrected by a signal correlation with defined chirped reference signals, wherein the reference signal yielding the maximum correlation is used for the linearization of the signal phase.

According to example embodiments of the invention, the linearization and the reconstruction of the signal can be performed using machine or deep learning algorithms.

To this end, FIG. 6 depicts the algorithm for relinearizing a signal with a single reflection.
I: A chirped signal with an accelerated phase is captured.
II: FRFTs with a certain angle range are carried out and the height of the peak is measured.
III: The angle leading to the highest value is determined as the least chirped and hence best reconstructed signal.

Further advantageous example configurations of the method according to the invention are described below, which configurations relate to the captured measurement signals, in particular to the optical coherence interferometry-based measurement systems used to this end.

For example, the measurement signals originate from slowly tuned swept source systems, which have tuning frequencies<2 kHz, in particular <100 Hz.

In particular, the measurement signals originate from OCT systems, which have coherence lengths of the tunable laser of for example 10 mm to 1000 m, in a particular example 20 to 100 mm.

The tunable laser of the utilized OCT system should have a sweep range between 1 and 100 nm, in particular 2 and 20 nm, and a central wavelength between for example 700 and 1400 nm, in particular examples a central wavelength around 780, 830, 1050 or 1300 nm.

A particularly advantageous example configuration of the method according to the invention should be considered that of being able to ascertain the eye length from temporal M-scans, for the purposes of which a two-dimensional signal representation, with depth coordinate and time coordinate, is necessary.

The depth scans showing the local reflectivity levels along the depth axis are strung together for such a two-dimensional representation. Then, a peak, e.g., from the corneal interior surface, is identifiable in the 2D image as a line, with the brightness of the line being proportional to the OCT signal. The second relevant peak is the signal from the retina. Depth position changes may arise here, for example if the measurement is carried out in the vicinity of the fovea centralis or if the nerve fiber layer dominates the signal from the retina instead of the pigment epithelium. Such changes can be captured very easily in a 2-dimensional representation, or it is also possible to determine from where the dominant signal of the retina actually originates. This 2-D representation can also be referred to as self-scanning OCT, with the movement of the measurement beam on the retina arising from the usually involuntary movements by the measured subject themselves.

Furthermore, axial positions of structure signals can also be intuitively interpolated or extrapolated in a 2-D representation should these be attenuated or lost in one or more depth scans as a result of poor detection of the backscattered light or speckle effects. If enough depth scans are recorded, these contain a sufficient number of reference signals for interpolation and extrapolation. Furthermore, it is possible to graphically ascertain a mean distance between different structure signals, for example by regression.

With respect to the source, the configurations set forth below are proposed for optimizing the method.

By way of example, the source can only drive to randomized spectral points (the number of sampling points is lower here than the number corresponding to the Nyquist sampling theorem), with the signal reconstruction then being implemented iteratively by use of a plurality of recorded interference signals. The advantage is in this case the fast recording by use of fewer points and the avoidance or reduction of movement artifacts. Then, the reconstruction can be implemented, for example by use of known methods such as the Allebach algorithm*. (See, e.g., K. D. Sauer, Allebach, IEEE Trans. CAS-34/12 (1987)).

The aforementioned approach also works with defined (non-randomized) sets of spectral points. Or, only parts of the spectrum are tuned by the source, with the signal reconstruction then being implemented within the scope of post-processing. As a rule, the spectral parts lead to axial scans with a low axial resolution. Combining a plurality of scans with different portions then allows the original axial resolution to be re-established. Like above, recording the spectral portion helps shorten the measurement time and avoid movement artifacts.

Below, further example configurations of the proposed method in relation to the compensation of axial, lateral, and further movement artifacts are described.

For example, the movement correction can be calculated from temporal M-scans in the optical frequency range, for the purposes of which a two-dimensional signal representation with spectral coordinate and time coordinate is required.

However, it is also possible to calculate the lateral movement correction by way of a signal reconstruction by partial spectra.

According to example embodiments of the invention, a lateral movement correction can be implemented by synchronous recording and comparison of depth scans of two laterally offset beams.

According to further example embodiments of the invention, the general movement and signal correction can likewise be implemented by “machine learning” algorithms. To this end, actual data with movement artifacts and the correction thereof can be used for training machine learning algorithms. Alternatively, synthetic data that simulate typical movement artifacts are used for the purposes of training the machine learning algorithms.

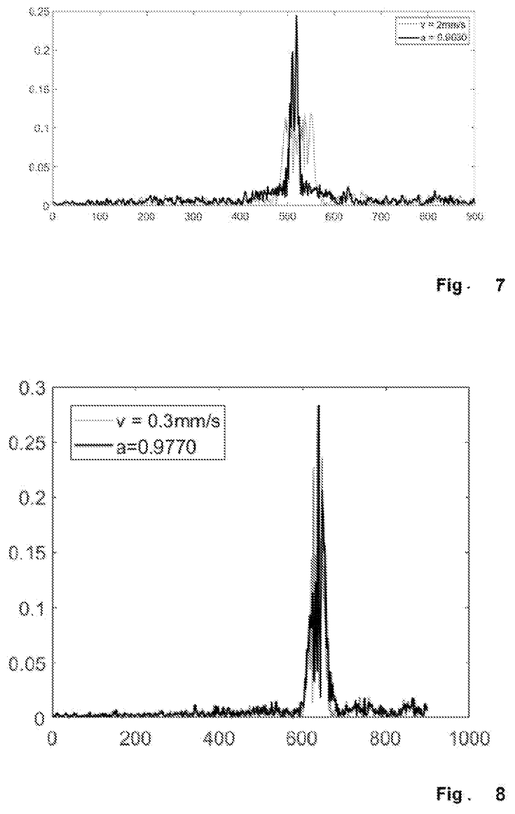

FIGS. 7, 8 and 9 show, in example fashion, a Fourier transformed spectrum prior to the reconstruction (blue) and the peak (orange) generated therefrom by reconstruction with FRFT, for measurements of a moving measurement object. The bandwidth before the reconstruction was approximately 50 nm at a sweep time of 0.05 s.

FIG. 7 shows the result for a measurement object moving at a speed of 2 mm/s, wherein the sweep time was 0.025 s.

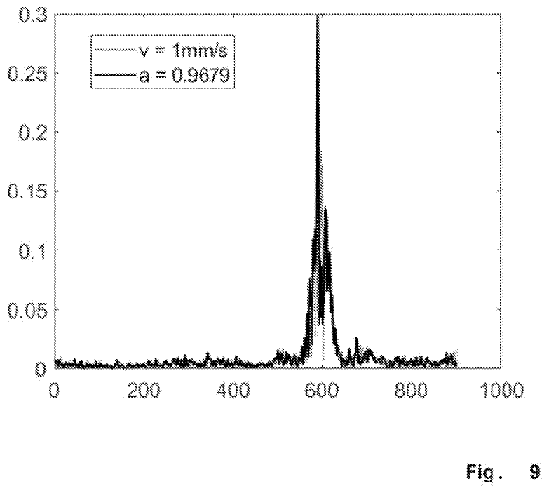

FIG. 8 shows the result for a measurement object moving at a speed of 0.03 mm/s, wherein the sweep time was 0.05 s.

FIG. 9 shows the result for a measurement object moving at a speed of 1 mm/s, wherein the sweep time was 0.063 s. The value a arises from:

$$a = \frac{2}{π} α .$$

Using the solution according to the invention, a method is provided that allows artifacts generated in measurement signals of OCT systems by moving measurement objects to be compensated. In particular, this is achieved without additional technical means, for example a movement or acceleration detector.

Here, the signal reconstruction is implemented without the aid of additional reference signals in respect of the movement of the measurement object and only by way of adapted algorithms.

In particular, the method according to the invention uses laser diodes which allow the construction of cost-effective biometric measurement systems, which ensure a high sensitivity and a sufficient reproducibility.

The proposed method works at sweep rates of <1 kHz.

Consequently, this allows optical biometry to become established not only in industrial countries but also in newly industrialized countries, where many patients have very pronounced cataracts.

1. (canceled)

2. A method for compensating the artifacts generated in measurement signals of swept source OCT systems by moving measurement objects, the method comprising:
implementing signal reconstruction without aid of additional reference signals in respect of movement of the measurement objects and only by application of especially adapted algorithms; and
implementing the compensation by application of a fractional Fourier transform (FRFT).

3. The method as claimed in claim 2, further comprising, for two or more reflections with the same speed:
a) iteratively altering a free parameter of the FRFT, until a quality function reaches a maximum value,
b) calculating the FRFT of the measured signal for a certain number of angles,
c) determining a parameter with the maximum signal value according to the FRFT,
d) using said FRFT for the relinearization of the entire original signal, and
e) wherein a reconstructed, non-chirped signal arises by application of the relinearization by remapping.

4. The method as claimed in claim 2, wherein a quality function of signal components summed over measurement depth lies above a defined threshold.

5. The method as claimed in claim 3, further comprising restricting the free parameter to expected axial speeds.

6. The method as claimed in claim 2, further comprising compensating at least one of axial movement artifacts, lateral movement artifacts, and further movement artifacts.

7. The method as claimed in claim 6, further comprising implementing the compensation by application of a relinearization by remapping.

8. The method as claimed in claim 2, further comprising, for multiple reflections:
a) capturing a signal consisting of two or more reflections including a first reflection with the same speed,
b) if the first reflection arises from a single surface, cutting the first reflection from a remainder of the signal for this signal,
subjecting the signal to Fourier transform, inverse transforming the signal again and extracting the signal's phase,
c) using the extracted phase for the relinearization of the entire original signal, and
d) wherein a reconstructed, non-chirped signal arises by application of the relinearization by remapping.

9. The method as claimed in claim 29, further comprising also correcting nonlinear chirps by a signal correlation with defined chirped reference signals, wherein the reference signal yielding the maximum correlation is used for the linearization of the signal phase.

10. The method as claimed in claim 2, wherein the measurement signals originate from slowly tuned swept source systems, which have tuning frequencies<2 kHz.

11. The method as claimed in claim 10, wherein the measurement signals originate from slowly tuned swept source systems, which have tuning frequencies<100 Hz.

12. The method as claimed in claim 2, wherein the measurement signals originate from slowly tuned swept source systems, which have coherence lengths of the tunable laser of 10 mm to 1000 mm.

13. The method as claimed in claim 12, wherein the measurement signals originate from slowly tuned swept source systems, which have coherence lengths of the tunable laser of 20 to 100 mm.

14. The method as claimed in claim 2, wherein the measurement signals originate from OCT systems with a sweep range between 1 and 100 nm.

15. The method as claimed in claim 14, wherein the measurement signals originate from OCT systems with a sweep range between 2 and 20 nm.

16. The method as claimed in claim 2, wherein the measurement signals originate from OCT systems, the tunable laser of which has a central wavelength between 700 and 1400 nm.

17. The method as claimed in claim 2, wherein the measurement signals originate from OCT systems, the tunable laser of which has a central wavelength around 780, 830, 1050 or 1300 nm.

18. The method as claimed in claim 2, further comprising ascertaining the eye length from temporal M-scans, wherein there is a two-dimensional signal representation with depth coordinate and time coordinate.

19. The method as claimed in claim 18, further comprising stringing together the depth scans showing the local reflectivity levels along the depth axis for the two-dimensional signal representation.

20. The method as claimed in claim 18, further comprising, for the two-dimensional signal representation, interpolating or extrapolating axial positions of attenuated or missing structure signals intuitively.

21. The method as claimed in claim 20, further comprising using reference signals from other depth scans for the interpolation or extrapolation of structure signals.
